(19) United States
(12) Patent Application Publication
(10) Pub. No.: US 2026/0157384 A1
(43) Pub. Date: Jun. 11, 2026

(54) APPARATUS AND METHOD FOR SUPPLYING A PRESERVATIVE IN A BEVERAGE WITH PRESSURE SENSORS

(71) Applicant: LANXESS Deutschland GmbH, Köln (DE)

(72) Inventors: Jonas BURGHOLZ, Köln (DE); Erasmus VOGL, Bergisch Gladbach (DE)

(21) Appl. No.: 18/707,532

(22) PCT Filed: Nov. 2, 2022
(86) PCT No.: PCT/EP2022/080545

§ 371 Date: May 3, 2024

(30) Foreign Application Priority Data
Nov. 4, 2021 (EP) 21 206 578.3

(51) Int. Cl. A23B 70/10; A23B 2/00; A23B 2/792

(52) U.S. Cl. CPC A23B 70/10; A23B 2/001; A23B 2/792

(57) ABSTRACT

Apparatus for preserving beverages, having a measuring device which is configured for determining a flow rate of a liquid flowing through a beverage line, and having a pump device which is configured for supplying a preservative, in particular dialkyl dicarbonates, into the beverage line, and having at least one receiving container configured for receiving the preservative, wherein the pump device is controllable as a function of a flow rate determined by the measuring device,
wherein
the apparatus has a first and a second pressure sensor, wherein the first pressure sensor and the second pressure sensor each measure a pressure of the preservative.

### BACKGROUND OF THE INVENTION

The invention relates to an apparatus and a method for preserving beverages and to the use of the apparatus for this purpose.

Preservatives such as dialkyl dicarbonates, sulphur dioxide, natamycin, benzoates or sorbates are used in the beverage industry for the cold sterilisation of non-alcoholic carbonated or still fruit juice drinks, fruit juices, wines, non-alcoholic wines, ciders, iced teas and other beverages. Dialkyl dicarbonates, such as dimethyl dicarbonate or diethyl dicarbonate in particular, are a special cold sterilising agent with a number of advantages. The outstanding advantage here is the fact that, in contrast to hot filling, taste and colour are not affected.

Compared to persistent preservatives, such as sodium benzoate or benzoic acid or potassium sorbate or sorbic acid, the advantage lies in the absence of any flavour impairment and the disappearance of the effect. Due to the decomposition of dialkyl dicarbonates into harmless components, no preservative is consumed by the actual consumer.

Compared to cold aseptic filling, the significantly lower investment costs in plant technology are a well-known advantage of using dialkyl dicarbonates.

In the state of the art, only on-line diaphragm dosing pumps are used to add dialkyl dicarbonates. Otherwise, uniform and reliable distribution in the beverage cannot be guaranteed. One advantage of diaphragm pumps is that their pump chamber is completely sealed.

The apparatus with diaphragm pumps usually consists of a magnetically or electrically driven diaphragm pump, storage vessels, an apparatus attached to the beverage line for atomising the dialkyl dicarbonate, the flow meter attached to the beverage line and an electronic control. Dosing pumps of this type are usually permanently installed in the beverage line.

The dosing pumps should be suitable for several different performance parameters, in particular for small and very small quantities. In addition, these dosing pumps should have a high dosing accuracy, a high atomisation pressure and a wide control range.

The mode of operation of these devices is based on the on-line measurement of the beverage flow rate prevailing in the beverage pipe and the quantity of dialkyl dicarbonate to be dosed calculated in parallel. Dialkyl dicarbonates are thus in each case proportionally dosed into the beverage pipe in the required quantity. Examples of these pumps are the VelcorinDT devices from Lanxess.

When treating beverages, for example non-alcoholic soft drinks or wine or mixed beer drinks, cold sterile treatment with dialkyl dicarbonates may be necessary, for example to combat bacteria or yeasts. The aforementioned dosing devices are therefore used for treatment.

WO1998042983A1 discloses a dosing pump for dosed delivery of liquids.

The dosing pumps used for this type of apparatus and methods must fulfil different performance parameters. On the one hand, they should be suitable for feeding small or very small quantities. In addition, these dosing pumps should have a high level of accuracy, but at the same time provide a high atomisation pressure and also have a wide control range, in particular for a wide variety of applications.

However, it has been shown that extremely precise monitoring of the quantity of dialkyl dicarbonate to be injected is desirable during injection. As the diaphragm pumps work with relatively strong bursts of liquid quantities, in particular when the individual pump stroke is carried out, it is relatively difficult to measure these quantities of dimethyl dicarbonate.

Commercially available flowmeters are not always suitable for accurately mapping the small quantities of liquid, the large fluctuations and the pressure and speed surges. In the past, therefore, analogue inductive level sensors or scales were used to accurately measure the quantities of dimethyl dicarbonate.

However, these sensors have the disadvantage that they are relatively sensitive to vibration of the liquid surface.

The present invention is therefore based on the object of improving the monitoring of the supply of the preservative.

### SUMMARY OF THE INVENTION

An apparatus according to the invention for preserving beverages has a measuring device which is suitable and intended for determining a flow rate of a liquid flowing through a beverage line and, in particular, of a beverage. Furthermore, the apparatus has a pump device which supplies a preservative and in particular dialkyl dicarbonates into the beverage line and at least one receiving container for receiving the preservative (which is preferably arranged upstream of the pump device in a conveying direction of the preservative). The pump device can be controlled as a function of a flow rate of the beverage determined by the measuring device.

According to the invention, the apparatus has a first and a second sensor and in particular a first and a second pressure sensor, wherein the first sensor and in particular the pressure sensor and the second sensor and in particular the pressure sensor each measure a value characteristic of the preservative and/or a value characteristic of the flow rate of the preservative and in particular a pressure of the preservative.

A redundancy of pressure sensors is therefore proposed in particular within the scope of the invention.

For example, there is a relationship between the pressure and the delivery rate in a delivery line and/or the flow rate of the liquid.

In addition to or instead of a pressure sensor, a (weight force) sensor (for example in the form of a load cell) can also be used. For example, the weight force of a container containing the preservative can be measured. A difference in weight force can be used to determine the quantity of liquid removed from the container and, in turn, to the delivery rate.

The applicant's internal state of the art has shown that corresponding pressure sensors are not reliable in many cases. For example, the sensors can easily have electronic defects. Unfortunately, this is problematic in terms of safety, because incorrect level measurement can firstly lead to overfilling or underfilling of a storage container, which in turn can lead to the leakage of dialkalydicarbonates or to failure of the dosage. Secondly, errors in the level measurement can lead to errors in the calculation of the actual quantities of disinfectant dosed. However, inaccurate or incorrect dosing into the beverage should be avoided.

In a preferred embodiment, the apparatus has a processor device which uses the measured pressure and/or a change in pressure to determine an amount of preservative supplied to the beverage line, for example taking into account a difference in weight of an amount of liquid corresponding to this amount of preservative. For example, a specific pressure difference measured within a container or a weight difference of the receiving container filled with the preservative can be used to infer a weight difference of the liquid in the container and this weight difference in turn can be used to conclude to a volume difference.

In a further advantageous embodiment, the apparatus has a further delivery device and in particular a further pump device, which delivers the preservative from the original receiving container (transport container) into the measuring receiving container. In particular this can be realized by using a vacuum pump or using compressed air.

It has now been found that if some or all pressure sensors are generally inserted in at least duplicate, it is possible not only to avoid the problems described above but also to derive further diagnostic data. Particularly important sensors can be duplicated or even triplicated.

A preferred apparatus within the meaning of the invention has, for example, a storage container containing dimethyl dicarbonate and a lance in this container for drawing dimethyl dicarbonate into a buffer vessel. However, it is also possible to press up from the storage container in the sense of the invention instead of suction. The lance guides the dialkyl dicarbonate into a buffer vessel, from the buffer vessel a dosing pump removes the sterilising agent on the suction side and guides it on the pressure side—preferably via a nozzle—into the beverage or into the beverage line.

The applicant has also discovered that pressure sensors are a relatively simple way of detecting the supplying of the preservative to the beverage. However, it has also been shown that pressure sensors are sometimes very expensive or do not achieve the desired reliability in cheaper variants. Therefore, the invention proposes to provide two redundant pressure sensors which determine the pressure of the preservative. Preferably, the pressure sensors can be operated and/or read independently of each other.

However, it should be noted that instead of redundant pressure sensors, redundant sensors of other types, for example redundant flow sensors or weight sensors, could also be used. The applicant therefore reserves the right to also claim protection for an apparatus and a method which use redundant flow sensors or weight sensors.

Particularly preferably, the pressure sensors and/or the apparatus allow online flow measurement and, in particular, indirect online flow measurement.

One way of measuring and monitoring the amount of dimethyldicarbonate is to use pressure sensors. For example, a small tank or a tube or burette is used to store dialkalydicarbonate. The fill level within the storage vessel can now be determined using a pressure sensor, as the applied liquid pressure, minus the air pressure, is proportional to the fill level in the tank, tube or burette. The pressure sensor and, in particular, the at least two pressure sensors can be installed at various points in the storage vessel. For example, the pressure sensor or the pressure sensors can be used near the bottom of the storage vessel to electronically determine a maximum and minimum fill level in the container and preferably to regulate the apparatus accordingly. As mentioned above, a pressure difference can be used to conclude to a fill level difference.

Furthermore, the invention also permits proportional dosing of the preservative also as a function of the values output by the at least two pressure sensors.

Preferably, the apparatus has a control device which controls the pump device as a function of at least one pressure sensor and preferably of both pressure sensors or the values output by these.

Furthermore, it is possible for the apparatus to have a flow measuring device which measures a flow of the preservative, in particular in the direction of the beverage line. Preferably, this flow measuring device is arranged on or in a pressure line that extends from the pump device. In particular, the flow measuring device is arranged in a connecting line that connects the pump device to the beverage line.

The pressure sensor is particularly preferably a pressure transmitter. Particularly preferably, this pressure sensor is therefore also suitable and intended to output measured values that are characteristic of a pressure of the liquid, in particular of the preservative.

In a preferred embodiment, the pressure sensor has a diaphragm for pressure measurement arranged inside a housing and in particular inside a stainless steel housing. In a further preferred embodiment, the pressure sensor is an electrically operated pressure sensor. Preferably, the pressure sensor is supplied with an operating voltage.

In a further preferred embodiment, the pressure sensor or the pressure sensors have a piezoresistive measuring cell and/or a thin-film measuring cell. Preferably, a maximum pressure that can be measured with the pressure sensor is greater than 5 bar, preferably greater than 10 bar, preferably greater than 20 bar and particularly preferably greater than 40 bar.

In a further preferred embodiment, the pressure sensor has a step response time that is less than 50 ms, preferably less than 40 ms, preferably less than 30 ms, preferably less than 20 ms and particularly preferably less than 10 ms. In this way, pressure differences can be determined very quickly.

Preferably, the pressure sensor(s) can be used at ambient temperatures between −40° C. and +85° C. In addition, the pressure sensor(s) can be used at temperatures of the preservative that are between −40° C. and +125° C., preferably between −20° C. and 100° C., preferably between −10° C. and 90° C. and particularly preferably between 0° C. and 70° C.

In a further preferred embodiment, at least one pressure sensor has a screw thread in order to be screwed onto an element of the apparatus.

Pressure sensors with the above properties were deliberately selected by the applicant in order to ensure safe operation of a corresponding apparatus.

Particularly preferable, the pressure sensor allows a wireless output of these measured values. In a particularly preferred embodiment, the pressure sensor is a differential pressure sensor. Preferably, the pressure sensor is arranged in such a way that a delivery rate of the preservative can be determined directly from the pressure difference.

Preferably, at least one pressure sensor is suitable and intended to output a signal that uniquely identifies this pressure sensor. In this way, it is possible to determine within a system which pressure value was output by which pressure sensor. In this way, a possibly defective pressure sensor can be determined very quickly in the event of a fault, for example.

Preferably, at least one pressure sensor can be replaced during operation of the apparatus.

One of the pressure sensors is particularly preferably a redundant pressure sensor. Preferably, both pressure sensors are arranged in the same area of the system and/or measure the same pressure as intended. Particularly preferably both pressure sensors output the same values for the pressure. It would be possible for the first pressure sensor and the second pressure sensor to be arranged adjacent to each other.

Preferably, the first and second pressure sensors are arranged in an area of the apparatus in which the same pressures of the preservative are to be expected.

In a preferred embodiment, the apparatus has a comparison device that compares the pressure value measured by the first pressure sensor and the pressure value measured by the second pressure sensor. It is possible for a processor device to check whether any differences in the output pressures are within a predetermined tolerance range or within a predetermined threshold range.

It is also possible that the processor device is suitable and intended to carry out a plausibility check of the values output by the pressure sensors. If, for example, one of the two pressure sensors fails completely and/or outputs technically unrealistic values, the values of the second pressure sensor can be used for control purposes for at least temporary operation. In this case, the user can also be informed that a specific pressure sensor needs to be checked. It is also possible for an alarm to be issued if there is too great a deviation between the two pressure sensors.

The pressure is preferably measured several times and/or continuously. Preferably, a pressure curve is measured. The amount of preservative added to the beverage (per unit of time) can be deduced from this pressure curve.

Preferably, a control device also controls the apparatus and in particular the pump device on the basis of the measured values output by at least one of the pressure sensors. Several procedures would be conceivable here. For example, it would be conceivable for the apparatus to be controlled on the basis of the value from one of the sensors and for the second pressure sensor to be used to check that the first sensor is functioning correctly.

It would also be conceivable for the apparatus to be controlled on the basis of a measured value resulting from the measured values of the two pressure sensors, for example on the basis of an average value of these values.

The apparatus particularly preferably has a storage device that stores the pressure values output by the pressure sensors over a predetermined period of time. It is also possible that a progression of the recorded pressure values is determined over time.

In this way, for example, gradually changing system states can be detected. An upcoming failure of a pressure sensor can also be detected in this way.

Particularly preferably the pressure sensors are of the same type and/or identical construction. Preferably, these are arranged in such a way that they output essentially the same values during operation when functioning correctly. For example, in the case of a liquid line, both pressure sensors can be arranged in identical alignment on this liquid line.

In a further advantageous embodiment, the apparatus has a removal device which removes the preservative from the receiving container or a receiving container. Preferably, this removal device is detachably arranged on the receiving container. Advantageously, this receiving container can be exchangeable. Particularly preferably, the removal device is designed in such a way that the preservative is sucked out from the receiving container.

Preferably, the removal device can be designed as a lance or suction lance or suction pipe. The suction is preferably performed using in particular the above-mentioned pump device. A line can be provided that leads to the pump device or to a further receiving container.

In a preferred embodiment, a sensor device and in particular a pressure sensor and/or a flow sensor device is assigned to the removal device. This pressure sensor is particularly preferably arranged on an end section and/or a tip of the removal device or the removal lance, in particular an end section that protrudes into the preservative during operation. However, it would also be possible for the sensor device associated with the removal device to be a flow sensor.

Thus, a further advantageous aspect of the invention are (pressure) sensors located at the tip of the lance, which are used to draw dialkyl dicarbonate from the storage container. These sensors allow a level indicator in the storage container and further control of the dosed quantity.

The pump device is particularly preferably a diaphragm pump and, in particular, a magnetically and/or electrically actuated diaphragm pump.

Particularly preferably, the apparatus has a further receiving container, in particular in the form of a buffer container, which can be filled with preservative removed from the receiving container. This buffer container is particularly preferably arranged in the flow path of the preservative between the receiving container and the pump device. Preferably, the pump device removes the preservative from said buffer container.

Preferably, the first pressure sensor and the second pressure sensor are arranged in this buffer container and/or assigned to this buffer container. For example, two sensors can be located in the buffer container or buffer vessel at the bottom of the container. In addition, two or one sensor can also be provided at the overflow or the upper liquid level of this buffer container. For example, the pressure sensors arranged at the bottom of the buffer container can measure a pressure of the preservative arranged in the buffer container.

In a further preferred embodiment, the apparatus has at least one (suction) line arranged between the receiving container and the pump device, and preferably one or the first and second pressure sensors are arranged in or on this suction line. This suction line is particularly preferably provided between the buffer vessel and the pump device. However, it would also be possible for a corresponding suction line to be arranged between the receiving container and the further receiving container or the buffer container. Particularly preferably, two pressure sensors are provided both in the suction line and in the above-mentioned buffer container.

Preferably, a receiving volume of the second receiving container is smaller than a receiving volume of the first receiving container.

This means that the apparatus preferably contains two pressure sensors in the suction line, which also allows the correct function of the suction and the pump to be monitored.

In a preferred embodiment, the apparatus has at least one further pressure sensor and preferably at least two further pressure sensors, which is or are arranged downstream of the pump device in the direction of flow of the preservative. In this embodiment, the further pressure sensor or sensors are preferably provided in a pressure line that supplies the preservative from the pump device to the supply point in which the preservative is transferred to the beverage line.

A pressure sensor in the pressure line allows additional diagnostics for the correct functioning of the pump, preferably via pressure progression curves. The pressure progression curves of the dosing pump can also be used as diagnostic indicators to monitor the pump function.

Particularly preferably, the apparatus has an injection device to supply the preservative into the beverage line. This may be a nozzle, for example, which allows the preservative to be introduced into the beverage line under high pressure. For this purpose, a pressure sensor or even two pressure sensors can be provided in the area of this injection device.

At least one further sensor, and in particular at least two further sensors, are particularly preferably assigned to the buffer container. These can also be pressure sensors, but it is also possible that they are fill level sensors that check the pressure level in the buffer container.

Particularly preferably, the buffer container has a receiving volume which is greater than 50 ml, preferably greater than 100 ml and preferably greater than 200 ml. Particularly preferably, the buffer container has a volume which is less than 12 litres, preferably less than 8 litres, preferably less than 5 litres and preferably less than 3 litres.

In a further advantageous embodiment, the apparatus has a display device for displaying characteristic or essential data for the process (the supply of the preservative). For example, a pressure value can be displayed, or also a value that is characteristic of a flow rate or further values. Besides or in addition, it would also be possible to display errors, such as the failure of a measuring device or a sensor.

In a further advantageous embodiment, the apparatus has a calibration device for calibrating the sensor devices. For example, it is possible for this calibration device to calibrate two redundant pressure sensors (or also other sensors such as flow sensors) so that their values are equalised during the calibration process. In particular, it is possible to teach-in the pressure sensors in this way.

In a further advantageous embodiment, a third pressure sensor is provided in addition to the first and second pressure sensors, wherein at least one, preferably at least two, of these pressure sensors are redundant. In this case, three pressure sensors per measuring point can be used advantageously. In this case, a deviating probe or a deviating sensor can be sorted out immediately (in particular by calculation) by means of adjustment and fault tolerance definitions. In this case, the apparatus can continue to work and the service requirement for replacing the faulty probe or faulty pressure sensor can be processed with sufficient time.

The pressure sensors are preferably designed as probes.

This makes it possible to use three pressure sensors per measuring point. In this case, a deviating probe can be sorted out—preferably immediately—in particular mathematically by means of adjustment and fault tolerance definitions. The dosing device can continue to work and the service requirement to replace the faulty probe can be processed with sufficient time.

The present invention is further directed to a method for preserving beverages, wherein a measuring device determines a flow rate of a liquid flowing through a beverage line, and in particular of a beverage, and a pumping device delivers a preservative and in particular dialkyl dicarbonates into the beverage line, and wherein the preservative is received in a receiving container, wherein the pump device being controlled as a function of a flow rate determined by the measuring device.

According to the invention, the apparatus has a first and a second sensor and, in particular, a pressure sensor, wherein the first (pressure) sensor and the second (pressure) sensor measure at least one pressure of the preservative. However, it would also be possible, alternatively or additionally, for other properties such as a fill level or a flow rate (of the preservative) or a weight force of the receiving container filled with the preservative to be measured (in particular redundantly).

The pressure of the preservative is understood in particular to be the pressure exerted by the (in particular liquid) preservative on a pressure sensor arranged in a predetermined area.

It should be noted that a first and a second pressure sensor are preferably used redundantly here. However, it would also be possible to use other sensor devices such as flow sensor devices redundantly (which measure a flow rate of the preservative accordingly). The applicant reserves the right to also claim protection for such embodiments.

In a further preferred method, a preservative is supplied from the receiving container into a further receiving container and in particular a buffer container. An active conveying device, such as in particular a second pump device, can preferably be used for this.

In a further preferred method, the measuring device that determines the flow rate of the liquid flowing through the beverage line is a flow sensor. However, it would also be possible for a pressure sensor to be used at this point. Particularly preferably at least two measuring devices are also provided, which determine the flow rate of the liquid flowing through the beverage line. Two redundant or one redundant measuring device is also particularly preferably here. In this way, higher safety can also be achieved when determining the flow rate through the beverage line.

The design of the pressure sensors in redundant/double form not only makes it possible to dispense with other more complicated components such as inductive flow meters or Coriolis mass or volume flow meters or inductive or capacitive probes. In addition, the redundant design allows a warning in the event of deviations in the measured variables of the two sensors or probes relative to each other and also in absolute terms above defined limits. This can lead to the switching of an alarm which in turn can trigger a maintenance procedure.

Dimethyldicarbonate is particularly preferably used as dialkyldicarbonate, even more preferably dimethyldicarbonate with a purity >99.8% is used as dialkyldicarbonate. In a further embodiment of the invention, dimethyldicarbonate is used which has been stabilised by suitable methods.

Such methods, such as the use of a phosphorus compound from the series of phosphorus oxides, phosphorus-oxygen acids and derivatives thereof, are known, for example, from EP 2 013 160 B1. EP 2 016 041 B1 describes the use of at least one protonic acid from the series of inorganic acids and organic carboxylic acids and their derivatives, wherein the organic carboxylic acids are saturated and mono-or polyunsaturated aliphatic monocarboxylic acids and saturated and mono-or polyunsaturated aliphatic di-and polycarboxylic acids and their derivatives are hydroxamic acids, hydroxycarboxylic acids, aldehyde and keto acids, for stabilising dialkyl dicarbonates against chemical and thermal degradation reactions, wherein the protonic acid or mixtures thereof is present in an amount of 0.01 to 100,000 ppm relative to dialkyl dicarbonates or their mixtures thereof.

In a further embodiment of the invention, dimethyldicarbonate is used in a mixture with phosphorus compounds, such as preferably phosphates, even more preferably with trimethylphoshate or phosphoric acid. Preferably, the phosphorus compound is used in an amount between 0.01 ppm and 1000 ppm relative to the total amount of the mixture of dimethyldicarbonate and phosphorus compounds.

### BRIEF DESCRIPTION OF THE DRAWINGS

Further advantages and embodiments are shown in the attached drawing:

In the drawing:

FIG. 1 shows a schematic representation of an apparatus according to the invention.

### DETAILED DESCRIPTION OF THE INVENTION

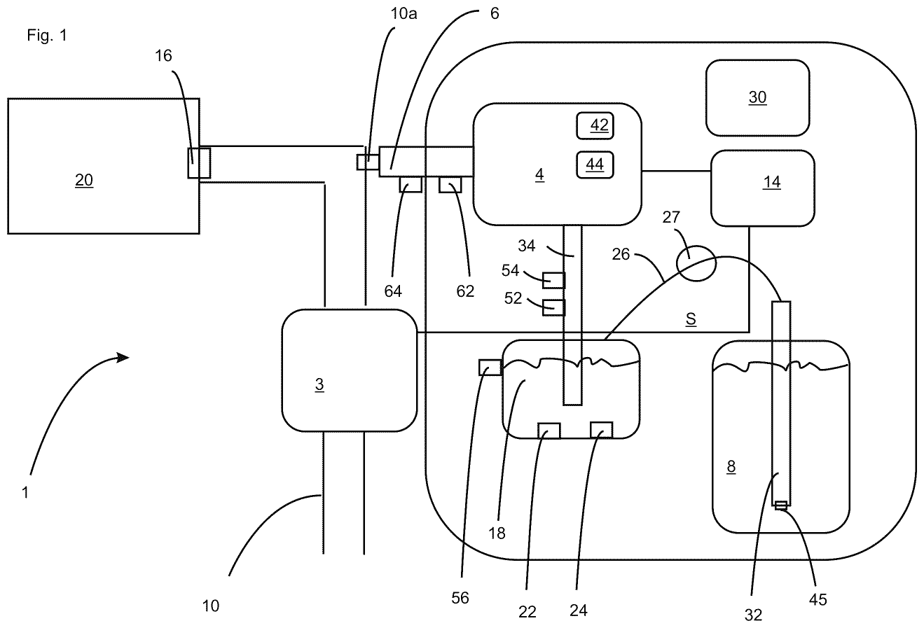

FIG. 1 shows a schematic representation of an apparatus 1 according to the invention, where the reference sign 10 indicates a liquid line and in particular a beverage line in which the liquid or beverage is supplied to a container 20.

The reference sign 3 indicates a measuring device, such as in particular but not exclusively a flow sensor, which is suitable and intended for determining the flow rate of the beverage flowing through the liquid line 10.

The reference sign 4 indicates a pump device which is used to supply a preservative to the beverage via a supply line and, in particular, a pressure line 6 and a nozzle 10a. This pump device 4 is controlled by a control device 14.

The measuring device 3 transmits a value to the control device 14 that is characteristic of the flow rate of the liquid flowing through the liquid line and the control device controls the pump device taking this value into account.

The reference sign 8 indicates a first receiving container which is used to hold the liquid preservative. This receiving container is preferably interchangeable and is preferably designed without a sensor device. The reference sign 32 indicates a removal device which is suitable and intended for removing the liquid from the receiving container. This removal device is preferably designed as a hollow lance which sucks the preservative out of the receiving container.

The reference sign 45 indicates a sensor and in particular a pressure sensor, which in an advantageous embodiment is arranged at a lower end of the removal device.

Via a connecting line 26 (shown only schematically), preservative removed from the receiving container 8 is supplied (for example by using a pump device 27) to a further receiving container 18, which is designed here as a buffer container. Furthermore, the supply and the function of the pump device 27 can also be realised by either applying overpressure to the container 8 and thus supplying the preservative further, or alternatively by applying negative pressure to the container 18, whereby the preservative is sucked into the container 18.

The pump device 4 can suck the preservative out of the buffer container 18 via a connecting line 34. However, the connecting line can also extend downwards from the bottom of the buffer container. The buffer container 18 allows the apparatus 1 to be operated further during the periods in which the receiving container 8 is replaced.

The buffer container can have various shapes and can be ventilated or sealed off from the environment. The buffer container can also be controlled via a valve and can be operated either ventilated or non-ventilated.

The height of the liquid column in the buffer tank influences the pressure difference to be measured in different filling states. Taller buffer tanks can therefore be advantageous in order to increase the measured values of the pressure differences in different filling states.

At least one first pressure sensor 22 and preferably two pressure sensors 22, 24 are arranged on a bottom of the buffer container. By means of this pressure sensor 22, a pressure of the liquid inside the buffer container 18 can be determined and thus the fill level of the liquid in the buffer container can be inferred.

In addition to or instead of the pressure sensors, at least two weight sensors could also be provided in particular, which measure the weight of the receiving container 18 filled with the preservative. These weight sensors (not shown) would preferably be arranged below the receiving container.

A change in the pressure results in a corresponding change in the fill level, and in this way it is possible to deduce the quantity of preservative conveyed by the pump device 4 and thus the quantity supplied to the beverage line 10.

By preferably providing two pressure sensors 22, 24, redundant measurement of the pressure is possible and thus a higher accuracy can be achieved.

In an alternative embodiment or additionally, a pressure sensor or preferably two pressure sensors 52, 54 can also be provided on the connecting line. The measured values output by these pressure sensors 52, 54 can also (additionally or alternatively) be used to infer a flow rate of the liquid through the connecting line 34 and thus a delivery rate.

The reference sign 56 indicates a fill level sensor that determines a fill level of the preservative within the receiving container 18. The data measured by this level sensor are used in particular to check the values output by the pressure sensors.

Preferably, the buffer container 18 therefore contains, for example, two sensors 22, 24 at the bottom of the buffer container 18, two sensors (only one sensor 56 shown) at the over-flow or upper liquid level, and two sensors in the pressure line.

The reference signs 62 and 64 indicate further pressure sensors which are arranged in the pressure line 6 in addition to or as an alternative to the sensors described above. In this way, too, a delivery rate of the preservative supplied to the beverage line 10 can be determined.

In addition, these pressure sensors can also be used to check whether the preservative is being supplied to the liquid line at a sufficient pressure or within specified limits.

The individual measured values from the sensors are preferably supplied to the control device 14, which also controls and in particular regulates the pump device on the basis of these measured values.

Preferably, the pump device also has at least one sensor device 42 and preferably several sensor devices 42, 44. These may be position sensors, for example, which determine the position of specific pump elements. In addition, they may also be current or voltage sensors which determine characteristic values for the operation of the pump device or the like.

Pressure sensors can also be used to record the pressure curves of an oil bed or oil supply of moving parts of the pump, for example, in order to allow conclusions to be drawn about the correct function of the dosing pump.

The values from these sensor devices are also preferably supplied to the control device 14 for controlling and/or regulating the pump device 4.

The reference sign 30 indicates a display and/or operating device for operating the apparatus. This display and/or operating device 30 is preferably suitable and intended for outputting information which are significant for the operation of the apparatus, such as measured pressures or the like. In addition, user inputs can preferably also be made via this display and/or operating device 30.

A fill level display and/or pressure display and/or flow rate display can be visualised directly on a touch panel (the display and/or operating device 30). This makes it possible to notify the operator of bottle changes in good time.

One advantage of the pressure sensors described above is their low price compared to other components.

An apparatus as shown in FIG. 1 was used to dose dimethyldicarbonate into an apple spritzer. After about 20 hours of operation, it was observed that the sensor 22 had an electronic defect. As the two sensors 22 and 24 were monitored by the control system and after averaging, the difference between the individual values and the mean value exceeded 10%, which served as a control limit and was exceeded, an alarm message could be triggered in the system control. This enabled the operator to take note of the fault. At the same time, by eliminating the faulty signal (outside the defined pressure limits), continued operation of the apparatus was ensured until the pressure sensor was replaced by only including one of the pressure sensors in the dosage control.

The applicant reserves the right to claim all features disclosed in the application documents as being essential to the invention, provided that they are new, either individually or in combination, compared to the state of the art. It should also be noted that the individual figures also describe features which may be advantageous in themselves. The person skilled in the art immediately recognises that a certain feature described in a figure can also be advantageous without the adoption of further features from this figure. Furthermore, the person skilled in the art recognises that advantages can also result from a combination of several features shown in individual figures or in different figures.

1-14. (canceled)

15. An apparatus for preserving beverages, having a measuring device which is configured for determining a flow rate of a liquid flowing through a beverage line, and having a pump device configured to supply a preservative, into the beverage line, and having at least one receiving container configured for receiving the preservative, wherein the pump device is controllable as a function of a flow rate determined by the measuring device,
wherein
the apparatus has a first and a second pressure sensor, wherein the first pressure sensor and the second pressure sensor each measure a pressure of the preservative.

16. The apparatus according to claim 15,
wherein
one of the pressure sensors is a redundant pressure sensor.

17. The apparatus according to claim 15,
wherein
the apparatus has a removal device which configured to remove the preservative from this receiving container.

18. The apparatus according to claim 17,
wherein
a sensor device is associated with the removal device.

19. The apparatus according to claim 15,
wherein
the pump device is a diaphragm pump or a piston stroke pump.

20. The apparatus according to claim 15,
wherein
the apparatus has a receiving container, configured to be filled with preservative removed from the receiving container.

21. The apparatus according to claim 15,
wherein
the first and second pressure sensors are assigned to the buffer container.

22. The apparatus according to claim 15,
wherein
the apparatus has at least one suction line arranged between the receiving container and the pump device.

23. The apparatus according to claim 15,
wherein
the apparatus comprises at least one pressure sensor arranged downstream of the pump device in the direction of flow of the preservative.

24. The apparatus according to claim 15,
wherein
at least one further sensor is associated with the buffer container.

25. The apparatus according to claim 15,
wherein
a third pressure sensor is provided in addition to the first and second pressure sensors, wherein two of these three pressure sensors are redundant.

26. A method for preserving beverages, wherein a measuring device determines a flow rate of a liquid flowing through a beverage line and a pump device delivers a preservative, into the beverage line, and wherein the preservative is received in a receiving container, wherein the pump device being controlled as a function of a flow rate determined by the measuring device,
wherein
the apparatus has a first and a second pressure sensor, wherein the first pressure sensor and the second pressure sensor each measure a pressure of the preservative.

27. The method according to claim 26,
wherein
the first pressure sensor and the second pressure sensor are operated redundantly.

28. The method according to claim 26,
wherein
the preservative is supplied from the receiving container into a further receiving container.
